(19) United States
(12) Patent Application Publication
(10) Pub. No.: US 2025/0356521 A1
(43) Pub. Date: Nov. 20, 2025

(54) ESTIMATION DEVICE AND ESTIMATION METHOD FOR GAZE DIRECTION

(71) Applicant: TOYOTA JIDOSHA KABUSHIKI KAISHA, Aichi-ken (JP)

(72) Inventor: Yuki KAWANA, Taito-ku (JP)

(21) Appl. No.: 19/200,670

(22) Filed: May 7, 2025

(30) Foreign Application Priority Data
May 17, 2024 (JP) 2024-081086

(51) Int. Cl. G06T 7/70

(52) U.S. Cl. CPC G06T 7/70; G06T 2207/20084; G06T 2207/30201

(57) ABSTRACT

Estimate processing is performed to estimate a gaze direction of a person shown in a two-dimensional image. In the estimate processing, three-dimensional pose information on a target person is acquired from the two-dimensional image in which the target person of the estimation of the gaze direction is shown. In the estimate processing, three-dimensional position information on an object shown in the two-dimensional image is acquired from the two-dimensional image. In the estimate processing, input information is further input to a neural network model that outputs the gaze direction of the person, and the output information on the neural network model is acquired as the gaze direction of the target person. The input information on the neural network includes the three-dimensional pose information and the three-dimensional position information acquired by the estimate processing.

The present application claims priority under 35 U.S.C. § 119 to Japanese Patent Application No. 2024-081086, filed on May 17, 2024, the contents of which application are incorporated herein by reference in their entirety.

### TECHNICAL FIELD

The present disclosure relates to a device and a method for estimating gaze direction of a person.

### BACKGROUND

JP2024029913A discloses a device for estimating the gaze direction of a person shown in a two-dimensional camera image obtained by capturing a space. The device of the related art estimates a three-dimensional pose and three-dimensional coordinates of a person including a face of the person shown in a two-dimensional camera image. The device of the related art also estimates the three-dimensional pose and three-dimensional coordinates of the head of the person shown in the two-dimensional camera image with reference to the estimated three-dimensional pose and three-dimensional coordinates, and estimates the front direction of the face region of the person as the gaze direction.

Examples of the documents showing the technical level in the technical field related to the present disclosure include JP2007006427A and JP2020027390A, in addition to JP2024029913A.

However, when accuracy of the estimation of the three-dimensional pose and the three-dimensional coordinates of the head of the person shown in the two-dimensional camera image is low, it is expected that the estimation in the front direction of the face region of the person is also low. In this case, the gaze direction of the person captured in the two-dimensional camera image cannot be correctly estimated, and it is difficult to estimate what the person is focusing on. Therefore, it is desirable that a method of estimating the gaze direction of the person shown in the two-dimensional camera image be studied from various fields and improved.

An object of the present disclosure is to provide a technique capable of estimating the gaze direction of the person shown in the two-dimensional image.

### SUMMARY

A first aspect of the present disclosure is a device for estimating a gaze direction of a person shown in a two-dimensional image, and having the following features.

The device comprises a memory device and processing circuitry. The memory device stores a two-dimensional image showing a target person of the gaze direction estimation and a neural network model for outputting the gaze direction of the person. The processing circuitry is configured to perform estimate processing to estimate the gaze direction of the target person.

The estimate processing includes: acquiring three-dimensional pose information on the target person from the two-dimensional image; acquiring three-dimensional position information on an object shown in the two-dimensional image from the two-dimensional image; and acquiring output information on the neural network model as the gaze direction of the target person by inputting input information to the neural network model.

The input information on the neural network model includes the three-dimensional pose information and the three-dimensional position information.

A second aspect of the present disclosure is a method for causing a computer to perform estimate processing to estimate a gaze direction of a person shown in a two-dimensional image, and has the following features.

The estimate processing includes: acquiring three-dimensional pose information on a target person from a two-dimensional image in which the target person of the gaze direction estimation is shown; acquiring three-dimensional position information on an object shown in the two-dimensional image from the two-dimensional image; and acquiring output information on a neural network model as the gaze direction of the target person by inputting input information to the neural network model that outputs the gaze direction of a person.

The input information on the neural network model includes the three-dimensional pose information and the three-dimensional position information.

According to the present disclosure, the three-dimensional pose information on the target person and three-dimensional position information on the object acquired from the two-dimensional image are input as the input information on the neural network model that outputs a gaze direction of a person, and thus output information on the neural network model can be acquired as the gaze direction of the target person. That is, according to the present disclosure, it is possible to estimate the gaze direction of the person shown in the two-dimensional image.

### BRIEF DESCRIPTION OF THE DRAWINGS

FIG. 1 is a block diagram illustrating an example configuration of an estimation device according to an embodiment of the present disclosure;

FIG. 2 is a block diagram illustrating a first function configuration example of the estimation device shown in FIG. 1; and

FIG. 3 is a block diagram illustrating a second function configuration example of the estimation device shown in FIG. 1.

### DESCRIPTION OF EMBODIMENT

Hereinafter, an embodiment of the present disclosure will be described with reference to the drawings. In the drawings, the same or corresponding parts are denoted by the same reference numerals, and the description thereof will be simplified or omitted.

### 1. Configuration Example of Estimation Device

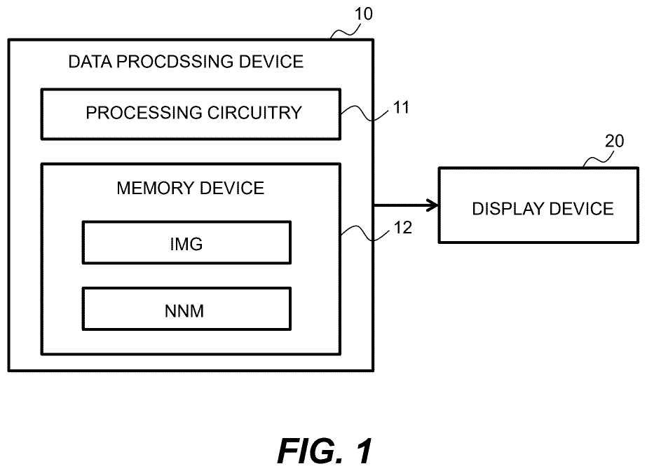

FIG. 1 is a block diagram illustrating an example configuration of an estimation device according to the embodiment of the present disclosure. In FIG. 1, a data processing device 10 and a display device 20 are illustrated as the configuration of the estimation device according to the embodiment. The display device communicates with the data processing device 10 via a communication network (not shown). The communication network is not particularly limited, and a wired or wireless network may be used.

The data processing device 10 includes at least one processing circuitry 11 and at least one memory device 12. Examples of the processing circuitry 11 include a general-purpose processor, a special-purpose processor, a central processing unit (CPU), a graphics processing unit (GPU), an application specific integrated circuit (ASIC), and a field-programmable gate array (FPGA). Examples of the memory device 12 include a hard disk drive (HDD), a solid state drive (SSD), a volatile memory, and a nonvolatile memory.

The processing circuitry 11 develops various programs stored in the memory device 12 and processes various data stored in the memory device 12. The data process by the processing circuitry 11 includes processing of two-dimensional image IMG. The processing of the two-dimensional image IMG includes estimate processing of a gaze direction GD (Gaze Direction) of a person shown in the two-dimensional image IMG. A person (hereinafter, also referred to as a “target person TG”) which is a target of the estimation of the gaze direction GD is an arbitrary person shown in the two-dimensional image IMG, and is set by the data processing device 10. When the data processing device 10 receives input information designating the target person TG, the target person TG may be set in accordance with the input information.

Here, examples of the two-dimensional image IMG include an image acquired by a RGB camera. The two-dimensional image IMG may be a composite of a plurality of images acquired from one RGB camera at different times or a composite of a plurality of images acquired from a plurality of RGB cameras (e.g., a person image and a background image).

In the embodiment, a one-shot two-dimensional image is considered as the two-dimensional image IMG. This is because it is assumed that information for estimating the gaze direction GD is only a one-shot two-dimensional image. When the RGB camera acquires a video, any of time-series images constituting the video corresponds to the one-shot two-dimensional image. When the two-dimensional image IMG is obtained by combining a plurality of images, the composite image corresponds to the one-shot two-dimensional image.

For the estimate processing of the gaze direction GD, a model NNM of neural network (NN) stored in the memory device 12 is used. The neural network model NNN is constructed to output the gaze direction GD. Examples of the neural network model NNN that outputs the gaze direction GD include a convolutional neural network (CNN).

The neural network model NNN is trained by supervised learning using training data including correct answer data, for example. The training of the neural network model NNN is performed using, for example, Equation (1) representing a relationship between an input x I and an output yi (i=1, . . . , N, N≥2).

$$yi = f ( \text{→Θ} , \text{→xi} ) \qquad ( 1 )$$

In Equation (1), a superscript arrow indicates a vector set. The input→xi includes the two-dimensional image IMG. The two-dimensional image IMG as the input→xi is an image set of horizontal width W and vertical width T, and is expressed by a vector of W*T. The output→yi is the estimated probability value. The output→yi includes gaze direction. The function f (→0) is a function of the neural network model NNN that holds the parameter set→Q, and outputs a two-dimensional vector.

The display device 20 displays various data. Examples of the display device 20 include a liquid crystal display, an organic EL display, and a head-up display. The various data displayed on the display device 20 may be provided to a user of the estimation device according to an embodiment. The various data displayed on the display device 20 includes gaze direction GD. When the gaze direction GD is displayed, the data processing device 10 may generate a composite image in which an arrow indicating the gaze direction GD is superimposed on the two-dimensional image IMG on which the gaze direction GD is estimated. The data processing device 10 may estimate an object located ahead of the gaze direction GD, that is, an object on which the target person TG focuses, and display information on the focused object on the display device 20.

### 2. Function Configuration Example

### 2-1. First Configuration Example

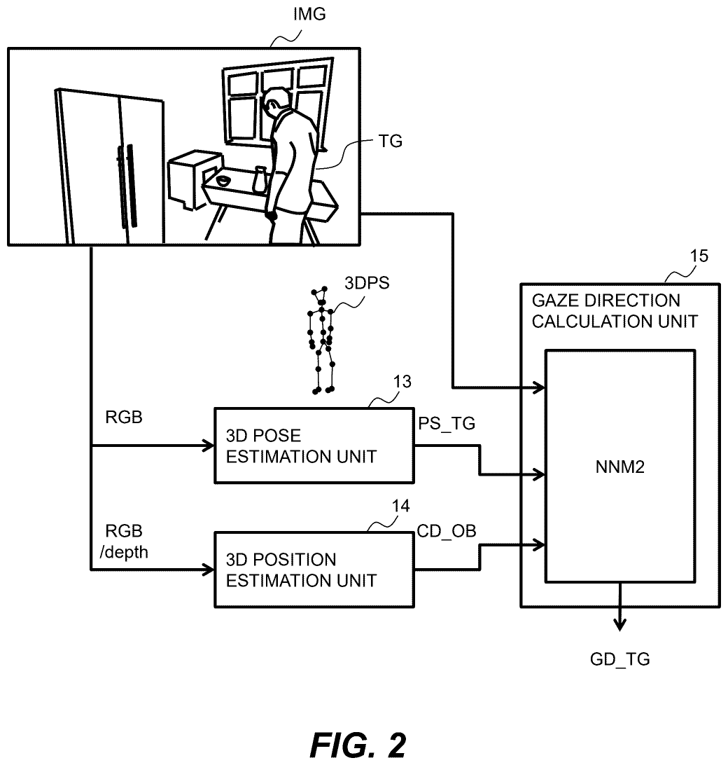

FIG. 2 is a block diagram illustrating a first example of a functional configuration of the data processing device 10 illustrated in FIG. 1. In the example shown in FIG. 2, a three-dimensional pose estimation unit 13, a three-dimensional position estimation unit 14, and a gaze direction calculation unit 15 are depicted as function blocks of the data processing device 10. These function blocks are realized by, for example, cooperation of the processing circuitry 11 and the memory device 12.

The three-dimensional pose estimation unit (3D pose estimation unit) 13 performs processing (3DPS processing) for estimating a three-dimensional pose 3DPS estimate of a person shown in the two-dimensional image IMG. In the 3DPS estimate processing, for example, a bounding box is added to a person (target person TG) shown in a two-dimensional image IMG (RGB image). Then, key points of the person (target person TG) are extracted from the bounding box, and the three-dimensional pose of the person is estimated. The three-dimensional pose is represented by a line connecting between parts such as a joint, a head, a hand, and a foot. The position of each part is represented by a three-dimensional coordinate system (X, Y, Z). Such estimate processing is a well-known technique, and the method is not particularly limited. For example, MeTRAbs, TransPose, and the like are used for 3DPS estimate processing. Three-dimensional pose PS_TG of the target person TG is transmitted to the gaze direction calculation unit 15.

The three-dimensional position estimation unit (3D position estimation unit) 14 performs processing (3D processing) for estimating the three-dimensional position (3DCD estimate coordinate) of an object shown in the two-dimensional image IMG. In the 3DCD estimate processing, for example, an object OB shown in the two-dimensional image IMG is detected using a You Only Look Once (YOLO) network, a Single Shot multi-box Detector (SSD) network, or the like. The object OB to be detected is, for example, a static object such as a building, a construction, or a natural object, or a moving object such as a person (a person other than the target person TG), a robot, a bicycle, or a vehicle. The information on the detected object OB includes information on the two-dimensional position of the object OB in the two-dimensional image IMG. The two-dimensional position of the object is represented by a two-dimensional coordinate system (X, Y).

In the 3DCD estimate processing, a depth image is generated from a two-dimensional image IMG (RGB image). The depth image can be generated using known machine learning models. In the 3DCD estimate processing, depth information on the object OB shown in the two-dimensional image IMG (i.e., information on the distances from the camera to the object) is further acquired from the depth image and added to the information on the two-dimensional position. Thus, data of the three-dimensional position CD_OB of the object OB is generated. The three-dimensional position of the object OB is represented by a three-dimensional coordinate system (X, Y, Z). Note that, in a case where the camera that acquires the two-dimensional image IMG is a camera (e.g., RGB-D camera) that can acquire a depth image, the three-dimensional position CD_OB may be generated using the depth image acquired simultaneously with the two-dimensional image IMG. The data of the three-dimensional position CD_OB is transmitted to the gaze direction calculation unit 15.

The gaze direction calculation unit 15 performs processing (GD calculation processing) to calculate the gaze direction GD of the target person TG (hereinafter, also referred to as a “gaze direction GD_TG”). In the GD calculation processing, neural network model NNN1 is used. In addition to the two-dimensional image IMG, the three-dimensional pose PS_TG of the target person NNN1 received from the three-dimensional pose estimation unit 13 and the three-dimensional position CD_OB of the object OB received from the three-dimensional position estimation unit 14 are used as inputs to the neural network model TG. That is, the input variables of the neural network model NNN1 are two-dimensional image IMG, three-dimensional pose PS_TG, and three-dimensional position CD_OB. The gaze direction GD_TG is obtained as information output from the neural network model NNN1.

### 2-2. Second Configuration Example

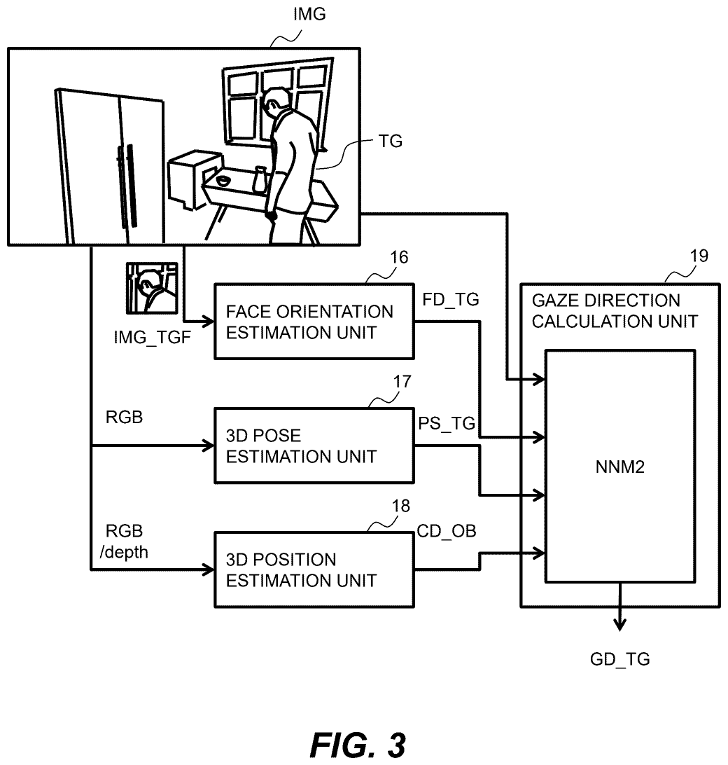

FIG. 3 is a block diagram illustrating a second example of a functional configuration of the data processing device 10 illustrated in FIG. 1. In the example shown in FIG. 3, a face orientation estimation unit 16, a three-dimensional pose estimation unit 17, a three-dimensional position estimation unit 18, and a gaze direction calculation unit 19 are depicted as function blocks of the data processing device 10. These function blocks are realized by, for example, cooperation of the processing circuitry 11 and the memory device 12.

The face orientation estimation unit 16 performs processing (FD estimate processing) for estimating the face orientation (face direction) of the target person TG. In the FD estimate processing, for example, a face image IMG_TGF of target person TG is extracted from two-dimensional image IMG (RGB image). Then, the position of the front of the face of the target person TG is estimated using the depth image generated from the face image IMG_TGF. The face orientation FD_TG is estimated based on the position of the front. The face orientation FD_TG is represented by a three-dimensional vector. The data of face orientation FD_TG is transmitted to the gaze direction calculation unit 15.

In the second example of the FD estimate processing, a depth image is generated from the two-dimensional image IMG (RGB image) without extracting the face image IMG_TGF. Then, the face orientation FD_TG is estimated based on the position of the front of the face of the target person TG estimated using the depth image. In the third example of the FD estimate processing, the three-dimensional pose of the target person TG in the two-dimensional image IMG is estimated. Examples of the method to estimate the three-dimensional pose of the target person TG include a method by the three-dimensional pose estimation unit 13 described in FIG. 2. Then, the face orientation FD_TG is estimated based on the three-dimensional pose of the target person TG. In the second or third example, data of face orientation FD_TG is also transmitted to the gaze direction calculation unit 15.

The function of the 3D pose estimation unit 17 is the same as that of the three-dimensional pose estimation unit 13 described in FIG. 2. The function of the 3D position estimation unit 18 is the same as that of the three-dimensional position estimation unit 14 described with reference to FIG. 2.

The gaze direction calculation unit 19 performs processing to calculate gaze direction GD_TG (GD calculation processing). In the GD calculation processing, neural network model NNN2 is used. The neural network model NNN2 is input with the two-dimensional image IMG, the face orientation FD_TG received from the face orientation estimation unit 16, the three-dimensional pose PS_TG of the target person TG received from the three-dimensional pose estimation unit 17, and the three-dimensional position CD_OB of the object OB received from the three-dimensional position estimation unit 18. That is, the input variables of the neural network model NNN2 are two-dimensional image IMG, face orientation FD_TG, three-dimensional pose PS_TG, and three-dimensional position CD_OB. The gaze direction GD_TG is obtained as information output from the neural network model NNN2.

### 3. Effect

According to the embodiment, the gaze direction GD_TG can be obtained as output information by inputting the three-dimensional pose PS_TG of the target person TG and the three-dimensional position CD_OB of the object OB together with the two-dimensional image IMG to the neural network model NNN having the two-dimensional image in which the target person is shown, the three-dimensional pose of the target person, and the three-dimensional position of the object shown in the two-dimensional image as input variables and the gaze direction of the target person as an output. Alternatively, by adding face orientation FD_TG of target person TG to the input variable, gaze direction GD_TG can be obtained as output information. That is, according to the embodiment, the gaze direction GD_TG of the target person TG shown in the two-dimensional image IMG can be estimated. Even if the two-dimensional image IMG is a one-shot image, the gaze direction GD_TG of the target person TG shown in the two-dimensional image IMG can be estimated.

What is claimed is:

1. A device for estimating a gaze direction of a person shown in a two-dimensional image, comprising:
a memory device configured to store a two-dimensional image showing a target person of the gaze direction estimation and a neural network model for outputting the gaze direction of the person; and
processing circuitry configured to perform estimate processing to estimate the gaze direction of the target person,
wherein the estimate processing includes:
acquiring three-dimensional pose information on the target person from the two-dimensional image;
acquiring three-dimensional position information on an object shown in the two-dimensional image from the two-dimensional image; and
acquiring output information on the neural network model as the gaze direction of the target person by inputting input information to the neural network model,
wherein the input information on the neural network model includes the three-dimensional pose information and the three-dimensional position information.

2. The device according to claim 1, wherein:
the estimate processing further includes acquiring face orientation information on the target person in the two-dimensional image; and
the input information on the neural network model further includes the face orientation information.

3. The device according to claim 1,
wherein the two-dimensional image includes a one-shot two-dimensional image.

4. A method for causing a computer to perform estimate processing to estimate a gaze direction of a person shown in a two-dimensional image,
wherein the estimate processing includes:
acquiring three-dimensional pose information on a target person from a two-dimensional image in which the target person of the gaze direction estimation is shown;
acquiring three-dimensional position information on an object shown in the two-dimensional image from the two-dimensional image; and
acquiring output information on a neural network model as the gaze direction of the target person by inputting input information to the neural network model that outputs the gaze direction of a person,
wherein the input information on the neural network model includes the three-dimensional pose information and the three-dimensional position information.

5. The method according to claim 4, wherein:
the estimate processing further includes acquiring face orientation information on the target person in the two-dimensional image; and
the input information on the neural network model further includes the face orientation information.

6. The method according to claim 4, wherein:
wherein the two-dimensional image includes a one-shot two-dimensional image.
